(19) United States
(12) Patent Application Publication
(10) Pub. No.: US 2021/0371040 A1
(43) Pub. Date: Dec. 2, 2021

(54) Bike frame and method for manufacturing thereof

(71) Applicant: Isinnova S.r.l., Brescia (BS) (IT)

(72) Inventor: Cristian Fracassi, Brescia (BS) (IT)

(21) Appl. No.: 17/309,166

(22) PCT Filed: Nov. 5, 2019
(86) PCT No.: PCT/IB2019/059494

§ 371 Date: May 2, 2021

(30) Foreign Application Priority Data
Nov. 6, 2018 (IT) 102018000010085

(51) Int. Cl. B62K 19/08; B62K 19/40

(52) U.S. Cl. CPC B62K 19/08; B62K 19/40

(57) ABSTRACT

A method of manufacturing a frame of a bike having a front wheel, a rear wheel, a saddle, a fork, and a bottom bracket includes the steps of providing a sheet-shaped element, cutting the sheet-shaped element along at least a predetermined shape to form at least one shaped sheet-shaped element, and bending of the shaped sheet-shaped element around at least one bending line to produce a bent sheet-shaped element, which defines a frame. The sheet-shaped element has a pair of substantially flat portions with an edge in correspondence of the at least one bending line, the portions of such pair being reciprocally faced and spaced apart at a predetermined distance.

### FIELD OF THE INVENTION

The present invention relates to the technical field of bicycles, and it particularly focuses on a bike frame.

### BACKGROUND OF THE INVENTION

As well known, bike frames are manufactured by welding several tubular elements generally made of metal, such as aluminum. On the other hand, monoblock frames which therefore do not require any additional welding or wrapping processing are also well known.

Anyway, such frames have a plurality of substantially circular and/or tubular elements which must be reciprocally coupled.

From the application WO 2004/014717 a bike frame manufactured with a pair of aluminium or titanium sheets by bending a shaped planar element is well known.

However, such frames are particularly expensive and difficult to manufacture.

Furthermore, all the known frames have standard shapes, not allowing the user to customize both the dimensions and the aesthetic aspect thereof.

### SUMMARY OF THE INVENTION

Object of the present invention is to overcome, at least partially, the drawbacks illustrated above, by providing a bike frame having high functionality and cost-effectiveness.

Another object of the present invention is to provide a bike frame having particularly simple constructive features.

Another object of the present invention is to provide a customizable bike frame.

Another object of the present invention is to provide a bike frame with high aesthetic pleasantness.

Another object of the present invention is to provide a manufacturing method of a bike frame having high functionality and cost-effectiveness.

Another object of the present invention is to provide a manufacturing method of a bike frame that is particularly rapid.

Another object of the present invention is to provide a manufacturing method of a bike frame for bikes of different dimensions and shapes.

Another object of the present invention is to provide a bike having high functionality and cost-effectiveness.

Such objects, as well as others that will be clearer hereinafter, are fulfilled by a method for manufacturing a bike frame, by a bike frame and by a bike in accordance with what is herein described, shown and/or claimed.

The dependent claims define advantageous embodiments of the invention.

### BRIEF DESCRIPTION OF THE DRAWINGS

Further features and advantages of the present invention will become more evident by reading the detailed description of some preferred but not exclusive embodiments of the invention, illustrated as a non-limiting example, with the help of the annexed drawings wherein:

FIGS. 1-4 are axonometric schematic views of a bike comprising the frame 1;

FIGS. 5-10 are schematic views of an example of a manufacturing method for a bike frame 1.

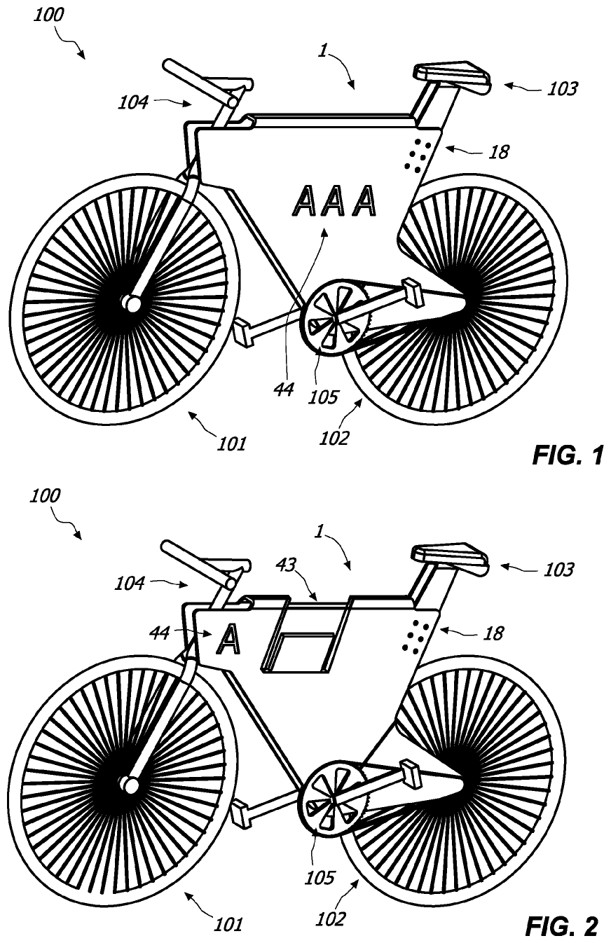

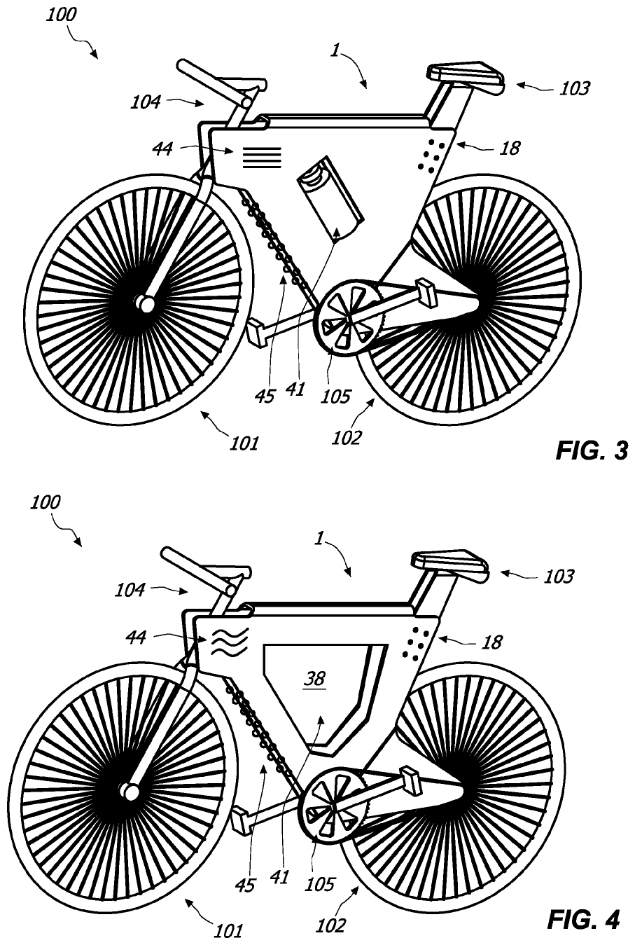

### DETAILED DESCRIPTION OF SOME PREFERRED EMBODIMENTS.

With reference to the attached figures, it is here described a frame 1 for a bike 100. The bike 100 may be of a per se known type. Basically, the bike 100 may therefore comprise a front wheel 101, a rear wheel 102, a saddle 103, a fork 104, a bottom bracket 105 and the frame 1.

Suitably, as better explained below, the frame 1 may comprise respective portions 12, 13, 14 and 15 in order to allow the coupling of the same frame 1 respectively with the rear wheel 102, the saddle 103, the fork 104 and the bottom bracket 105.

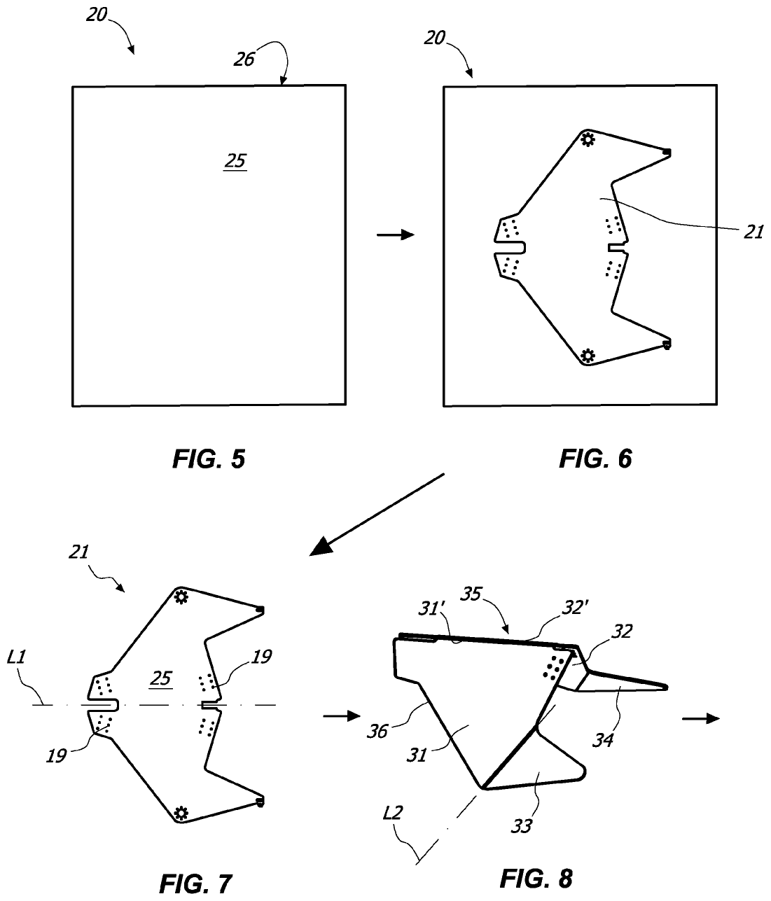

As schematically illustrated in FIGS. 5-9, the frame 1 may be manufactured starting from a substantially planar sheet-like element 20.

According to a preferred but not exclusive embodiment of the invention, the sheet-like element 20 may have at least one face 25 susceptible to remain visible, substantially continuous and/or substantially smooth. Preferably, the sheet-like element 20 may have a pair of opposite faces 25, 26 which may be substantially continuous and/or substantially smooth.

With “substantially continuous” we mean that one or both opposite faces 25, 26 may be continuous or having small discontinuities 38, as better explained below.

Suitably, one or both the opposite faces 25, 26 may furthermore have no ribs and/or stiffeners.

The sheet-like element 20 may be made of wood, polymeric material, metallic material and/or composite material.

Suitably, the sheet-like element 20 may be made of transparent material.

Preferably, the sheet-like element 20 may be made of polymeric material.

For example, the sheet-like element 20 may be made of polycarbonate (PC), possibly impact-resistant polycarbonate, or polymethylmethacrylate (PMMA).

Suitably the sheet-like element 20 may have a different thickness depending on the material. For example, in the event the material used is aluminium, the sheet-like element 20 may have a thickness of the order of 3-4 mm, whereas in the case the material used is polymeric, the sheet-like element 20 may have a thickness of the order of 6-10 mm.

Therefore, the sheet-like element 20 may be cut (FIG. 6) in order to manufacture a shaped sheet-like element 21.

Suitably, such cutting process may be carried out by a processing machine that therefore carries out a cutting operation on the sheet-like element 20.

Preferably, the cut may be carried out by a laser cutting and the processing machine may be a laser cutting machine, preferably a CNC machine.

The cutting machine may be an automated machine which may include a logical unit for data processing and cutting means connected to the first. Therefore the cutting means, which may be of a per se known type, may be movable along a cutting trajectory, so as to cut the sheet-like element 20 in order to form the shaped sheet-like element 21 according to a predetermined shaping.

Suitably, there may also be a data collection step regarding the cutting trajectory, so as to cut the sheet-like element 20 along to the cutting trajectory in accordance with the data collected in order to manufacture the customized shaped sheet-like element 21.

The data collection step may comprise a data entry step regarding the cutting trajectory in the automated machine. For example, such data entry may be manually carried out by a user, for example by a touchscreen display or buttons.

Possibly, the automated machine may comprise a data storage unit, operatively connected to the logical unit for data processing of a per se known type, operatively connected to the cutting machine containing data regarding different predetermined cutting trajectories.

Suitably, the data storage unit may contain the data collected during the data collection step, such as the data entered by the user.

Suitably, a logical unit for data processing operatively connected to the data storage unit may also be provided, so as the former may automatically send to the cutting machine the data regarding the type of cut to carry out, for example the cutting trajectory of the cutting means, so as to manufacture the sheet-like element having a predetermined shaping in accordance with such data.

Moreover, the same automated machine may cut the sheet-like element 20 according to one of the different cutting trajectories stored and/or entered, so as to manufacture shaped sheet-like elements 21 having different shaping according to requirements, in a simple and cost-effective way.

In this manner, the dimension of the frame 1 may be any and not necessarily a standard dimension. Indeed, thanks to the cutting step thus carried out, shaped sheet-like elements 21 of any dimension may be manufactured.

Preferably but not exclusively, the sheet-like element 20 may be cut in one single step, i.e. the cutting trajectory may define a single path. Thereby, the cutting step may be particularly rapid.

Anyway, the frame 1 may be manufactured starting from such shaped sheet-like element 21, therefore the different dimensions and/or shaping of the latter may determine different dimensions and/or shaping of the frame 1.

Thanks to such feature, the frame 1 may be customized according to the preference of a user.

For example, it may be possible to easily manufacture frames having different dimensions and/or appearance so as to manufacture bikes 100 having different dimensions and/or appearance, that is to say customized bikes.

According to a particular aspect of the invention, the customized frames 1 may be manufactured starting from a single typology of sheet-like element 20, i.e. from sheet-like elements 20 of equal dimension and/or shape and/or material, thus reducing costs and simplifying the warehouse management.

Suitably, regardless of the shape or the dimensions of the frame 21, the latter may be manufactured starting from a sheet-like element 20 having predetermined shape and/or dimensions.

In particular, the shaped sheet-like element 21, regardless of its shaping, may be always manufactured by cutting the sheet-like element 20 of such predetermined dimensions and/or shape. For example, the sheet-like element 20 may have a substantially rectangular shape and it may be 120 cm wide and 90 cm long, defining the predetermined dimensions of the same sheet-like element.

Advantageously, the shaped sheet-like element 21 and therefore the frame 1 may be manufactured starting from one single sheet-like element 20 having such predetermined dimension.

Thanks to such features, in the event a plurality of frames 1 are to be manufactured, regardless of the shape or the dimension of each frame 1, the frames 1 may be all manufactured starting from respective sheet-like elements 20 having the same shape and/or dimension and/or material.

Thereby, it may be possible to manufacture customized frames 1 in a simple, fast and cost-effective manner.

Suitably, according to requirements, the sheet-like elements 20 may have the same dimensions and/or material and/or shape and/or thickness. Preferably, the frames 1 may be manufactured starting from respective sheet-like elements 20 equal to each other, i.e. having identical shape, dimensions and material.

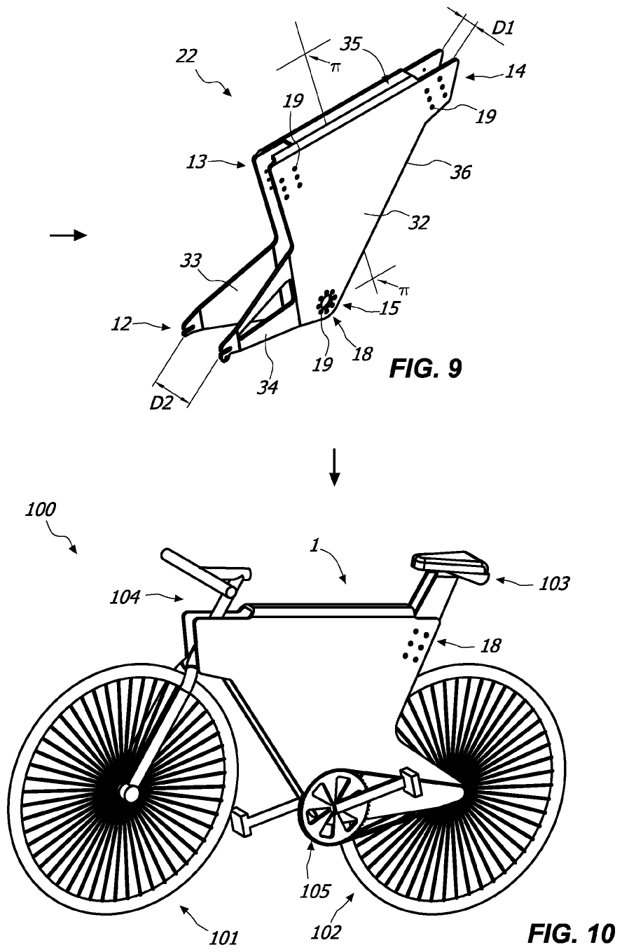

Once manufactured the shaped sheet-like element 21, the latter may be bent along one or more bending lines L1 (FIG. 8) so as to manufacture a bent sheet-like element 22 (FIG. 9).

The bending step may be carried out in the same working environment, for example in the same industrial shed. Possibly, the bending step may be carried out immediately after, i.e. consecutively the manufacturing of the shaped sheet-like element 21 so as the same shaped sheet-like element 21 is still malleable.

In other words, the cutting step of the sheet-like element 20 to manufacture the shaped sheet-like element 21 may be followed by the bending step of the latter in order to manufacture the bent sheet-like element 22.

On the other hand, the bending step of the shaped sheet-like element 21 may carried out afterwards, possibly in a different place. For example, the bending step may be carried out by heating the shaped sheet-like element 21. In other words, the sheet-like element 20 may be thermoformed.

For example, in the case the sheet-like element 20 is made of polymeric material, the same sheet-like element may be locally heated, i.e. in correspondence of a bending area 35, with hot air or heat lamps, and then the bending may be carried out. Preferably, it may be possible to heat at a lower temperature than the melting point, for example it may be possible to heat up to a deflection temperature (for example about 80-90° C. for polymers).

On the other hand, in the event the sheet-like element 20 is made of wood, it may be possible to use steam and humidity in correspondence of the bending area 35 so as to locally reduce the structural resistance of the same sheet-like element 21 and allow the bending.

In the event the sheet-like element 20 is made of metal, it may be possible to cold bend it, both manually and with a proper press brake.

Suitably, in the event the sheet-like element 20 is made of a material comprising carbon fibers, glass fibers or kevlar, the same shaped sheet-like element 21 may be bent before those materials are cross-linked and/or hardened. For example, the sheet-like element 20, may be cut in order to manufacture the shaped sheet-like element 21, and it may be bent in order to manufacture the bent sheet-like element 22 during the same step or during the immediately following processing steps.

Anyway, once the sheet-like element has been bent 22, it may have two portions 31, 32 substantially flat and reciprocally faced with the bending area 35 being interposed between them. In other words, the portions 31, 32 may extend from the bending area 35 on opposite sides with respect to the latter, so as to remain substantially reciprocally faced.

The face 25 may remain on sight, while the face 26 may remain internal.

The bending lines L1 may therefore cross the bending area 35.

In particular, each portion 31, 32 of the bent sheet-like element 22 may have a respective edge 31′, 32′ in correspondence of the bending area 35.

The flat portions 31, 32 may therefore be reciprocally faced and spaced apart of a predetermined distance D1. For example, such distance D1 may be between 1 cm and 15 cm, preferably it may be of about 5-6 cm.

The bent sheet-like element 22 may therefore define the frame 1. Preferably but not exclusively, the frame 1 may consist of the bent sheet-like element 22.

Possibly, some spacers interposed between the flat portions 31, 32 may be provided, so as to give higher rigidity to the frame 1

Afterwards, the frame 1 may therefore be coupled with the rear wheel 102, the saddle 103, the fork 104 and the bottom bracket 105 so as to manufacture the bike 100 through appropriate coupling means 18.

The coupling means 18 may comprise male and female elements, such as s plurality of holes 19, which may be coupled with respective female or male elements, such as a plurality of screws of the rear wheel 102, of the saddle 103, of the fork 104 and of the bottom bracket 105.

Therefore, a drilling step may be provided in order to form one or more holes on the sheet-like element 20 and/or on the shaped sheet-like element 21 and/or on the bent sheet-like element 22.

For example, the drilling step may be carried out before or after the cutting phase of the sheet-like element 20, preferably immediately before or immediately after it.

According to a particular aspect of the invention, the cutting and the drilling step may be carried out in the same working environment, for example inside the same industrial shed. Preferably, the cutting and the drilling step may be carried out by the same automated machine. In this case, the cutting machine may therefore be a cutting and drilling machine.

The holes 19 may be made in correspondence of areas 12, 13, 14 and 15 of the sheet-like element 20 which may define the coupling portions of the frame 1.

It is understood that the coupling means 18 may comprise other elements of a per se know type, such as plates, gaskets, dice or similar.

Moreover, additional connecting elements to allow the coupling of the saddle 103 and/or the fork 104 with their respective portion 13 and/or 14 may be provided. For example, the connecting element may be a connection sleeve to allow the coupling between the saddle 103 and the portion 13 of the frame 1. For example the connection sleeve may comprise one or more pairs of holes, correspondent to the holes 19 present on the portion 13, so as the connection sleeve and the portion itself 13 are reciprocally telescopically couplable.

Thereby, the saddle 103 may have different heights.

Similarly, it may be possible to couple the fork 104 with the portion 14. Possibly, a connecting element may be provided in order to allow the coupling of the fork 104 with the portion 14. Thereby, the fork 104 may be of any type. In other words, the connecting element may be an adapter element.

Suitably, the bent sheet-like element 22 may therefore comprise the portions 12, 13, 14 and 15 which may comprise the holes 19.

Preferably, each flat portion 31, 32 of the bent sheet-like element 22 may comprise holes 19.

For example, each flat portion 31, 32 may comprise a plurality of holes 19 placed in mutual correspondence, so as to allow the coupling with the bottom bracket 105 through one or more passing screws of a per se known type.

Analogously, the flat portions 31, 32 may comprise additional holes 19 placed in correspondence of the rear wheel 102, of the saddle 103 and of the fork 104 so as to allow the coupling of the latter with the first.

It is understood that the position of the holes 19 may be different according to requirements. For example, the holes 19 for the coupling with the bottom bracket 105 may be substantially placed along a circumference, while the holes for the coupling with the fork 104 may be substantially aligned.

As shown in the attached figures, the portion 12 may comprise a hole for the coupling with the wheel 102, the portions 13 and 14 may comprise a plurality of aligned couples of holes, such as six holes, and the portion 15 may comprise a central hole and a plurality of peripheral holes.

Suitably, the distance D1 may be such that at least one portion of the rear wheel 102, of the saddle 103, of the fork 104 and of the bottom bracket 105 remains interposed between the two flat portions 31, 32.

Thanks to the abovementioned features, the manufacture of the frame 1 may therefore be fast and easy. Moreover, the frame 1 may be particularly cost-effective.

According to a particular aspect of the invention, each flat portion 31, 32 may comprise an end area 33, 34 slightly bent around a bending line L2 so as the end areas 33, 34 are substantially divergent. Thereby, the distance D2 between the two end areas 33, 34 may be substantially greater than the distance D1.

Suitably, the bending step around the bending line L2 may be carried out before, after or simultaneously with the bending step around the bending line L1 of the sheet-like element 21.

For example, the two end areas 33, 34 may be placed in correspondence of the rear wheel 102.

It is therefore understood that the two portions 31, 32 are kept at a predetermined distance by the coupling means 18. To give greater detail, the frame 1 may have a substantially planar development, defining a main development plane π, and the two portions 31, 32 may lay in it or be coplanar to the plane π.

On the other hand, the coupling means 18 may oppose the forces acting on action lines transversal to the plane π.

Suitably, the coupling means 18 may be placed on opposite sides of the frame 1. In fact, as shown in the figures, each portion 31, 32 is reciprocally constrained above through the respective mutual edge 31′, 32′ in correspondence of the bending area 35, and is constrained below and laterally through the coupling means 18 of the frame with the bottom bracket 105 (below), the rear wheel 102 and the fork 104 (laterally on opposite sides).

Thereby, the structural rigidity of the frame 1 and, therefore, of the bike 100 is particularly high.

It is understood that the bike 1 may comprise additional elements, without departing from the scope of the invention.

Moreover, the rear wheel 102, the saddle 103, the fork 104 and the bottom bracket 105 may be of a per se known type.

Suitably, the frame 1 may have one or more compartments 41, 43. For example, one or more compartments 41 placed along the portions 31, 32 and one or more compartments 43 placed along the bending line 35 may be provided. For example, the compartments 41 may be suitable for containing flasks or various objects, meanwhile the compartments 43 may be suitable for containing tablets, computers, paperwork or similar.

In other words, one or both portions 31, 32 may comprise at least one or more discontinuities 38 defining the compartments 41, 43.

Possibly, despite the discontinuities 38, the frame 1 may still have a substantially continuous aspect. In other words, the space interposed among the rear wheel 102, the saddle 103, the fork 104 and the bottom bracket 105 may be substantially full unlike the tubular frames that are generally commercially available.

Thanks to the abovementioned features, the frame 1, and more generally the bike 100, may be particularly versatile.

Moreover, the same frame 1 may be aesthetically customized, according to requirements and/or preferences of the user.

The frame 1 may have one or more writings, logos or drawings 44 in correspondence of one or more faces 25, 26. For example, one or more parts of the faces 25, 26 may be screen-printed.

Possibly, moreover, one or more parts of the faces 25, 26 may be engraved, for example in order to make writings or drawings.

Moreover, lighting means such as one or more LED lights 45 may be provided.

Suitably, in the event the frame 1 is made of polycarbonate, the LED lights 45 may be placed near the edges 36 of the portions 31, 32 so as the light propagates inside the same portions 31, 32.

Thereby, the aesthetic result is particularly pleasant.

Moreover, the discontinuities of the portions 31, 32 and/or the engravings on the faces 25, 26 may interrupt the light propagation, thus creating a particularly pleasant aesthetic effect.

It is understood that the frame 1 may have a “double triangle” shape, in a per se known way. In particular, a first triangle may have the coupling portions 13 e 14 in correspondence of its upper ends and the coupling portion 15 in correspondence of the lower end. Suitably the area 35 may remain interposed between the two portions 13 e 14.

On the other hand, the other triangle may be defined by the end areas 33, 34 having a vertex in correspondence of the coupling portion 12 and the opposite base coupled or hinged on the first triangle.

Thereby the frame 1 will be highly structurally resistant.

The frame 1 thus created allows a high degree of customization as regards dimensions and shape. Moreover, thanks to this manufacturing method, this may happen with no additional costs.

Such method may also be particularly advantageous in order to manufacture a plurality of frames 1 and, in particular, to manufacture a plurality of frames 1 having different dimensions.

In fact, starting from a plurality of sheet-like elements 20, having the same shape and/or dimensions and/or material, it may be possible to manufacture different shaped sheet-like elements 21, and hence different frames 1.

Operatively, it may therefore be possible to provide a plurality of sheet-like elements 20 equal to each other. Preferably, such sheet-like elements 20 may be placed in a warehouse that may be inside, outside or far from the working environment, or preferably the warehouse may be inside the working environment.

For example, the working environment may be defined by an industrial shed within which a plurality of sheet-like elements 20 may be stocked, and the cutting machines and/or bending machines and/or drilling machines may be placed.

Therefore, it may be possible to collect one sheet-like element 20 from the abovementioned plurality of sheet-like elements.

On the other hand, preferably, it may be possible to collect a plurality of sheet-like elements 20.

Hereinafter we will refer to a plurality of sheet-like elements 20 processed in sequence, in order to manufacture a plurality of frames. On the other hand, it is understood that what described above may be equally valid to manufacture a single frame of any dimension starting from a single sheet-like element 20 belonging to the plurality of the same sheet-like elements stocked.

The sheet-like elements 20 may be placed in sequence on a working plane and moved along the same plane, for example through a conveyor belt.

Suitably, the cutting machine or the drilling machine may be placed along the working plane in a processing area so that the movement of the sheet-like elements 20 along the working plane intercepts, and preferably crosses, such processing area.

In other words, a plurality of sheet-like elements 20 may be consecutively placed along the conveyor belt. The latter may move until they reach the processing area where they are cut, or cut and drilled, according to specifications predetermined by the cutting machine, or by the cutting-drilling machine, so as to manufacture the shaped sheet-like element 21.

The latter may then be stocked, or sent to a working station for the bending, in order to carry out the bending step of the same, thus obtaining the bent sheet-like element 22.

On the other hand, the bending step may be carried out consecutively to the cutting step and/or drilling step. In other words, the drilling and cutting step may be carried out inside the same working environment. Preferably the bending and cutting steps may be carried out in a single working station.

From what described above, it is clear that the invention reaches the intended purposes.

The invention is susceptible to numerous modifications and changes. All the details may be replaced by other technically equivalent elements, and the materials may be different depending on requirements, without departing from the scope of the invention defined in the appended claims.

The invention claimed is:

1.-43. (canceled)

44. A method of manufacturing a frame of a bike comprising a front wheel, a rear wheel, a saddle, a fork, and a bottom bracket, the method comprising:
providing a sheet-shaped element having a plurality of coupling areas;
cutting and drilling said sheet-shaped element to produce a formed sheet-shaped element having a plurality of holes defined at said plurality of coupling areas to provide each coupling area with at least one hole, so as to enable a coupling of said frame with one or more of the rear wheel, the saddle, the fork, or the bottom bracket; and
bending said formed sheet-shaped element around at least one bending line to produce a bent sheet-shaped element that defines the frame of the bike,
wherein said bent sheet-shaped element has a plurality of flat portions with an edge in correspondence of said at least one bending line, at least some of the flat portions being reciprocally faced and spaced apart at a predetermined distance, and
wherein said sheet-shaped element is made of a polymeric material.

45. The method according to claim 44, wherein said polymeric material is a transparent material.

46. The method according to claim 44, wherein said polymeric material is polycarbonate.

47. The method according to claim 44, wherein said polymeric material is polymethylmethacrylate.

48. The method according to claim 44, wherein said sheet-shaped element has a rectangular shape.

49. The method according to claim 44, wherein the steps of cutting and bending steps are consecutively carried out in a single working environment.

50. The method according to claim 44, wherein the step of cutting is carried out by an automated machine, which includes a data processing logical unit and cutting tools operatively connected to the data processing logical unit, said cutting tools being movable along a cutting trajectory so as to cut said sheet-shaped element to form said formed sheet-shaped element according to a predetermined shaping.

51. The method according to claim 50, further comprising collecting data about said cutting trajectory so as to cut said sheet-shaped element along said cutting trajectory according to collected data so as to manufacture at least one customized shaped sheet-shaped element.

52. The method according to claim 51, wherein the step of collecting data comprises entering the data about said cutting trajectory in said automated machine.

53. The method according to claim 51, wherein said automated machine comprises a data storage unit operatively connected to said data processing logical unit, and adapted to contain the data collected in the step of collecting data.

54. The method according to claim 50, wherein the steps of cutting step and drilling step are carried out by said automated machine.

55. A frame for a bike comprising a front wheel, a rear wheel, a saddle, a fork, and a bottom bracket, the frame comprising:
a single sheet-shaped element made of a polymeric material bent around at least one bending line so as to provide a bending area and a plurality of flat portions (extending therefrom at opposite sides to remain reciprocally faced and spaced apart at a predetermined distance, said single sheet-shaped element having a plurality of coupling portions configured for coupling with respectively the rear wheel, the saddle, the fork, and the bottom bracket,
wherein each of said plurality of coupling portions has at least one hole at each of said coupling portions for the coupling with respectively the rear wheel, the saddle, the fork, and the bottom bracket.

56. The frame according to claim 55, wherein each of said portions of said sheet-shaped element has continuous opposite faces.

57. The frame according to claim 55, further comprising at least one connecting element to enable the coupling of at least one of the saddle and the fork with at least one of said coupling portions.

58. A bike comprising:
a frame according to claim 55.
